(19) United States
(12) Patent Application Publication
(10) Pub. No.: US 2020/0202626 A1
(43) Pub. Date: Jun. 25, 2020

(54) Augmented Reality Noise Visualization

(71) Applicant: Plantronics, Inc., Santa Cruz, CA (US)

(72) Inventors: David W Moody, Santa Cruz, CA (US); Shridhar K. Mukund, San Jose, CA (US)

(73) Assignee: Plantronics, Inc., Santa Cruz, CA (US)

(21) Appl. No.: 16/231,010

(22) Filed: Dec. 21, 2018

(51) Int. Cl. G06T 19/00; G10L 25/84; H04R 1/40; H04R 3/00

(52) U.S. Cl. CPC G06T 19/006; H04R 3/005; H04R 1/406; G10L 25/84

(57) ABSTRACT

Methods and apparatuses for identifying and indicating open space noise are described. In one example, a method includes receiving an audio sensor data from a plurality of microphones disposed at known locations throughout an open space. The method includes generating a three-dimensional sound map data from the audio sensor data. The method further includes generating an augmented reality visualization of the three-dimensional sound map data, which includes capturing with a video camera at a mobile device a video image of the open space, displaying the video image on a display screen of the mobile device, and overlaying a visualization of the three-dimensional sound map data on the video image on the display screen.

### BACKGROUND OF THE INVENTION

Noise within an open space is problematic for people working within the open space. Open space noise is typically described by workers as unpleasant and uncomfortable. Speech noise, printer noise, telephone ringer noise, and other distracting sounds increase discomfort. This discomfort can be measured using subjective questionnaires as well as objective measures, such as cortisol levels.

For example, many office buildings utilize a large open office area in which many employees work in cubicles with low cubicle walls or at workstations without any acoustical barriers. Open space noise, and in particular speech noise, is the top complaint of office workers about their offices. As office densification accelerates, problems caused by open space noise become accentuated. In the prior art, methods and apparatuses for identifying and indicating the extent of noise in an open space have been limited.

As a result, improved methods and apparatuses for identifying and indicating open space noise are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for augmented reality noise distraction visualization in one example.

FIG. 2 illustrates a simplified block diagram of the mobile computing device shown in FIG. 1 in one example.

FIG. 3 illustrates a sound map database of three dimensional sound map data in one example.

FIG. 4 illustrates an augmented reality sound map visualization of noise distraction activity in an open space.

FIGS. 5A-5B are a flow diagram illustrating generating an augmented reality visualization of three-dimensional sound map data in one example.

FIG. 6 illustrates a system block diagram of a server suitable for executing application programs that implement the methods and processes described herein in one example.

### DESCRIPTION OF SPECIFIC EMBODIMENTS

Methods and apparatuses for identifying and indicating noise in an open space are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

In one example embodiment of the invention, a method includes receiving an audio sensor data from a plurality of microphones disposed at known locations throughout an open space. The method includes generating a three-dimensional sound map data from the audio sensor data, which includes (a) detecting a voice activity from the audio sensor data, (b) detecting a speech level of the voice activity from the audio sensor data, (c) identifying a source location of the voice activity within the open space, (d) detecting a stationary noise activity from the audio sensor data, (e) detecting a stationary noise level of the stationary noise activity from the audio sensor data, and (f) identifying a source location of the stationary noise activity within the open space.

The method further includes generating an augmented reality visualization of the three-dimensional sound map data, which includes (a) capturing with a video camera at a mobile device a video image of the open space, (b) displaying the video image on a display screen of the mobile device, and (c) overlaying a visualization of the three-dimensional sound map data on the video image on the display screen.

In one example embodiment, a system includes a plurality of microphones disposed at known locations throughout an open space to output an audio sensor data. The system includes a first computing device and a second computing device. The first computing device includes a first device communications interface, one or more first device processors, and one or more first device memories storing one or more first device application programs executable by the one or more first device processors. The one or more first device application programs include instructions to receive the audio sensor data from the plurality of microphones. The one or more first device application programs include further instructions to generate a three-dimensional sound map data from the audio sensor data, including instructions to (a) detect a voice activity from the audio sensor data, (b) detect a speech level of the voice activity from the audio sensor data, (c) identify a source location of the voice activity within the open space, (d) detect a stationary noise activity from the audio sensor data, (e) detect a stationary noise level of the stationary noise activity from the audio sensor data, and (f) identify a source location of the stationary noise activity within the open space.

The second computing device includes a second device communications interface for receiving the three-dimensional sound map data from the first computing device, one or more processors, a video sensor providing a video sensor output, a video display device, and one or more location sensors providing a sensor output identifying a device location and viewpoint. The second computing device further includes one or more second device computer memories storing one or more second device application programs executable by the one or more second device processors. The one or more second device application programs include instructions to (a) receive the three-dimensional sound map data, (b) receive the video sensor output, (c) receive the sensor output identifying the device location and viewpoint, (d) generate an augmented reality visualization of the three-dimensional sound map data utilizing the video sensor output, the sensor output identifying the device location and viewpoint, and the three-dimensional sound map data, and (e) output the augmented reality visualization on the video display device.

In one example embodiment, a system includes a plurality of microphones disposed at known locations throughout an open space to output an audio sensor data, one or more video sensors disposed in the open space to output a video sensor data, and one or more computing devices. The one or more computing devices include one or more processors, one or more display devices to display the video sensor data, and one or more memories storing one or more application programs executable by the one or more processors. The one or more application programs include instructions to receive the audio sensor data from the plurality of microphones.

The one or more application programs further include instructions to generate a three-dimensional sound map data from the audio sensor data, which includes instructions to (a) detect a voice activity from the audio sensor data, (b) detect a speech level of the voice activity from the audio sensor data, (c) identify a source location of the voice activity within the open space, (d) detect a stationary noise activity from the audio sensor data, (e) detect a stationary noise level of the stationary noise activity from the audio sensor data, and (f) identify a source location of the stationary noise activity within the open space.

The one or more application programs further include instructions to generate an augmented reality visualization of the three-dimensional sound map data, which includes instructions to (a) capture with the one or more video sensors a video image of the open space, (b) display the video image on the one or more display devices, and (c) overlay a visualization of the three-dimensional sound map data on the video image on the one or more display devices.

In one example embodiment of the invention, a series of plug-and-play, WiFi-enabled, “smart microphones” are placed throughout an open office environment. Then, using augmented reality, the audio captured by those microphones is visualized/superimposed on top of a live video view of the open office setting on a tablet computer or other camera-ready device. The augmented reality view shows the noise in the open office in real time, clearly illustrating where audio problem hotspots exist in the setting. The augmented reality view may assist in installation of a soundscaping system where sound masking noise is output. The noise augmented reality visualization system allows visualization how the soundscaping system sculpts the audio environment to changing needs. In one example, cloud-based control systems are used. For example, before and after noise visualizations of the open space may be shown when a soundscaping system is installed.

In one example embodiment of the invention, a system includes a series of smart, IOT-enabled plug-and-play microphones that are also capable of communicating with one another for the purpose of proximity awareness and space mapping. The microphones are plug-in or battery operated so as to be quickly and easily be placed about an open space (e.g., a workplace). In operation, the microphones capture audio and transmit it via WiFi to a computer that will process the data. The augmented reality processing operates to merge the physical microphone placements in the space with proximity awareness of where they are located in relation to the tablet computer on which the open office is being visualized. In one example, this is handled by the Bluetooth connection to the tablet computer and via measurement of latency between individual microphones and from each microphone to the tablet computer. The augmented reality programming processes the audio signals and visualizes them onto the tablet computer's screen (i.e., superimposing them over live video) with the least amount of latency as possible.

As an alternative plan for mapping the space virtually and then combining it with the video feed physically, in a further embodiment, a central hub device placed in the center of the open office environment is utilized with which all the smart microphones are communicating. Through this, proximity to the central hub and all other microphones would map the space virtually and physically. Then, if the tablet computer and its live video feed are panned around the open office setting from the location of the central hub, the technology to merge the virtual and physical locations and space maps is more user friendly.

In one example embodiment, omnidirectional microphones are installed at known intervals in an environment. Audio is collected in a manner that allows augmented reality presentation. Each smart microphone can be a single omnidirectional microphone, but preferably is a microphone array. Advantageously, each microphone array allows for differentiation of distance, direction, angle, etc. Preferably each smart microphone includes seven channels: one downward/upward microphone, and six directional microphones at 60 degree increments facing outward. Using this configuration allows each smart microphone to determine sound coming from right underneath/above to solve, early in the process, location of at least some noise sources. In this manner, the system is able to easily localize some noise sources using a single smart microphone. Thus, the smart microphone may utilize one channel per smart microphone, seven channels per smart microphone, or something in between.

Microphone metadata is processed as needed. In one embodiment, voice activity detection (VAD) on each smart microphone distinguishes between speech signals and non-speech signals on each channel of the microphone. For each channel, a first type of message is sent for speech and a second type of message is sent for non-speech (e.g., stationary) noise. Messages are sent from each microphone to the central hub or other collection device. In one embodiment, a threshold intensity value/noise level is utilized such that when speech is received at microphone in excess of threshold, messages are sent. In a further embodiment, each message includes the measured noise level (e.g., in decibels).

In one embodiment, instead of smart microphones sending metadata to the central hub, the smart microphones send actual audio to the central hub, which then processes each channel of audio to generate the metadata. Advantageously, this may provide better noise source differentiation/localization. All data may be stored at the central hub for later processing and visualization. For example, in addition to real-time visualization, noise during a specific time and date in the past may be viewed.

In one embodiment, the locations of the smart microphones are determined with a calibration phase. In this embodiment, each smart microphone includes a speaker. During the calibration phase, each smart microphone plays a sound. The sound received by other smart microphones in the area is used to determine which smart microphone is adjacent to other smart microphones and how far apart they are to determine the topography of the office space. Each smart microphone is connected wirelessly to the central hub and/or cloud. In one embodiment, the smart microphones are connected to the central hub wirelessly using WiFi or Bluetooth. In a further embodiment, the distances between the smart microphones may be manually measured and recorded. The central hub device may synchronize the audio received from the smart microphones or the smart microphones may be time synchronized.

In one embodiment, the central hub operates as the processor for the augmented reality experience, storing noise metadata in a manner for rapid real-time visualization on a user viewing device such as a tablet computer. This allows for real-time generation of the AR experience. In one example, the tablet retrieves the metadata from the cloud. The metadata used for visualization is stored and conveyed in a manner to reduce processing/work done by the tablet.

The central hub (e.g., a server) receives and stores the microphone metadata. The server formats the data for easy rendering by the tablet. Since the server knows the location of all of the smart microphones, it annotates the incoming metadata appropriately. In one embodiment, the server creates a frame in time which is a 2D array of values for the room. Thus, at t=0, noise values for frame 0, at t=1 noise values for frame 1, etc. During visualization on the tablet, each value may correspond to a color. For example: light blue=quiet stationary noise, dark blue=loud stationary noise; light red=quiet people speaking, dark red=loud people. Different shades of a color may represent the intensity of noise. In a further embodiment, different colors may be used to indicate speech noise from different people, e.g., blue for a person A and green for a person B.

The server creates the visualization data, i.e., the frames, which are provided to the rendering device, e.g., the tablet computer. The tablet computer determines the user location and which direction the user is looking. The tablet computer creates the viewport, and then determines which values from the frames it is receiving are within the viewport. This is used to render the augmented reality experience. In one embodiment, a flat overview/frame of room is translated into columns of noise. The shading/visualization is determined by determining which columns of noise are visible in viewport.

In one embodiment, interpolation or assumptions are utilized to estimate resolution in a vertical direction. For example, assuming a certain height for people, if speech noise is detected, the speech noise is rendered with higher intensity at that height (e.g., a darker shade of a color, such as red). For example, a spherical visualization with a center at the assumed height is shown. Heuristics may be used to determine whether a noise source is located near the ceiling or floor.

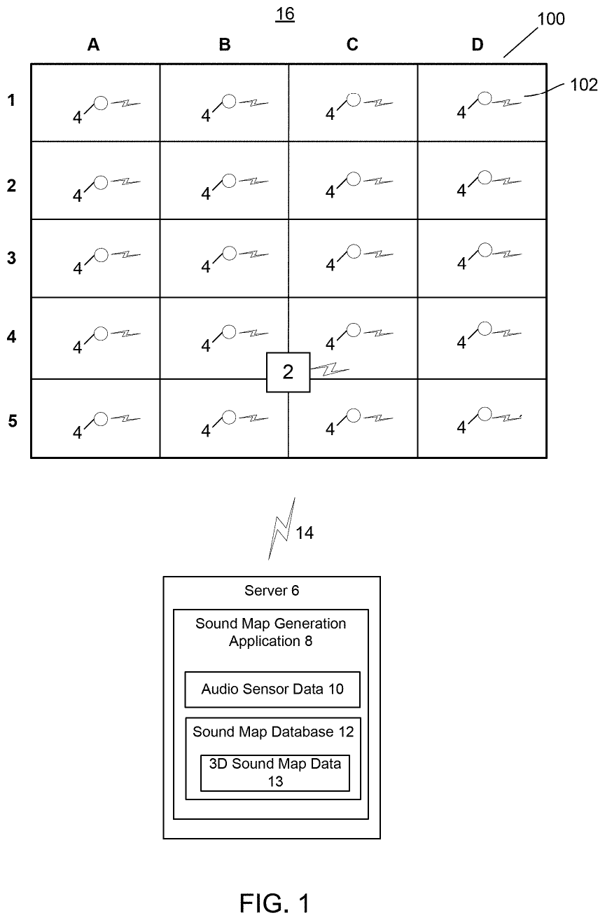

FIG. 1 illustrates a system 16 for augmented reality noise distraction visualization in one example. System 16 includes a plurality of microphones 4 disposed in an open space 100 to output audio sensor data 10. System 16 includes a mobile computing device 2 disposed in the open space 100 to display an augmented reality noise distraction visualization generated from the audio sensor data 10. In one example, the plurality of microphones 4 is disposed within the open space 100 in a manner wherein each microphone 4 corresponds to a region 102 (i.e., a geographic sub-unit) of the open space 100. For example, the microphone 4 is placed at the center of the region. In one example, each microphone 4 is a part of a microphone array including six directional microphones 4 oriented at sixty degree increments facing outward in the open space 100. One or more of the plurality of microphones 4 may be an omni-directional microphone. In one embodiment, each region 102 may include a loudspeaker for outputting sound masking noise in response to detected sound in the open space 100.

The system 16 includes server 6 storing a sound map generation application 8. In one embodiment, server 6 may be viewed as a central hub device for collected data. In one example, the sound map generation application 8 is configured to receive the audio sensor data 10, and generate three-dimensional sound map data 13 for storage in a sound map database 12. In one example, the audio sensor data 10 includes a plurality of measured decibel levels and the three-dimensional sound map data 13 comprises the plurality of measured decibel levels correlated to a plurality of locations. Server 6 may also adjust a sound masking volume level output from one or more loudspeakers of a soundscaping system. For example, the sound masking noise is a pink noise or natural sound such as flowing water.

Placement of microphones 4 in the open space 100 in one example is shown. In one example, microphones 4 are stationary microphones. For example, open space 100 may be a large room of an office building in which employee workstations such as cubicles are placed. In one example, one or more of microphones 4 are disposed in workstation furniture located within open space 100, such as cubicle wall panels. Microphones 4 may be disposed at varying heights within the room, such as at floor level and ceiling level.

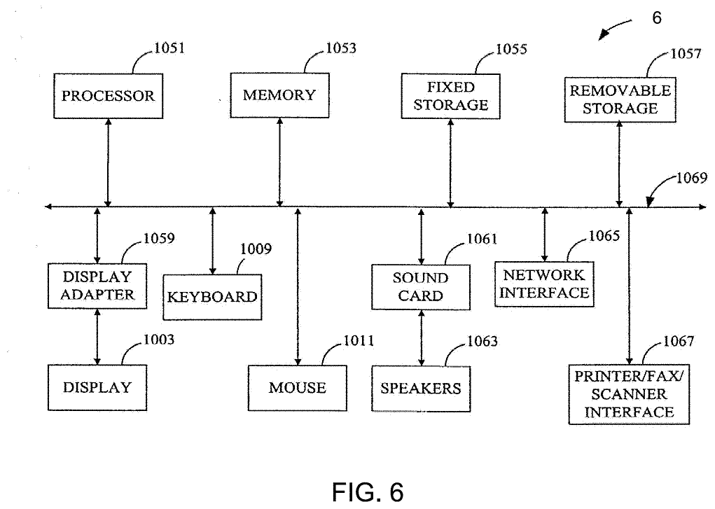

The server 6 includes a processor and a memory storing application programs comprising instructions executable by the processor to perform operations as described herein to receive and process microphone signals. FIG. 6 illustrates a system block diagram of a server 6 in one example. Server 6 can be implemented at a personal computer, or in further examples, functions can be distributed across both a server device and a personal computer such as mobile computing device 2.

Server 6 includes a sound map generation application 8 interfacing with each microphone 4 to receive microphone output signals (e.g., audio sensor data 10). Microphone output signals may be processed at each microphone 4, at server 6, or at both. Each microphone 4 transmits data to server 6.

In one example, the sound map generation application 8 is configured to receive a location data associated with each microphone 4. In one example, each microphone 4 location within open space 100 is recorded during an installation process of the server 6. For example, this location data is used to identify the source location (e.g., region) of sound distractors (e.g., a speech distractor, stationary noise distractor, or any other noise source) within open space 100 by identifying which sensor(s) the speech distractor is closest to.

In one example, sound map generation application 8 stores microphone data (i.e., audio sensor data 10) in one or more data structures. Microphone data may include unique identifiers for each microphone, measured noise levels or other microphone output data, and microphone location. For each microphone, the output data (e.g., measured noise level) is recorded for use by sound map generation application 8 as described herein.

Server 6 is capable of electronic communications with each microphone 4 via either a wired or wireless communications link 14. For example, server 6 and microphones 4 are connected via one or more communications networks such as a local area network (LAN), Internet Protocol network, IEEE 802.11 wireless network, Bluetooth network, or any combination thereof. In a further example, a separate computing device may be provided for each microphone 4.

In one example, each microphone 4 is network addressable and has a unique Internet Protocol address for individual control. Microphones 4 may include a processor operably coupled to a network interface, output transducer, memory, amplifier, and power source. Microphones 4 also include a wireless interface utilized to link with a control device such as server 6. In one example, the wireless interface is a Bluetooth or IEEE 802.11 transceiver. The processor allows for processing data, including receiving microphone signals and managing sound masking signals over the network interface, and may include a variety of processors (e.g., digital signal processors), with conventional CPUs being applicable.

The use of a plurality of microphones 4 throughout the open space 100 ensures complete coverage of the entire open space 100. Utilizing data received from these sensors, sound map generation application 8 detects a presence of a noise source from the microphone output signals. Where the noise source is undesirable user speech, a voice activity is detected. A voice activity detector (VAD) is utilized in processing the microphone output signals. A loudness level of the noise source is determined. Other data may also be derived from the microphone output signals.

In one example, sound map generation application 8 identifies a human speech distractor presence in the open space 100 by detecting a voice activity from the audio sensor data 10. Sound map generation application 8 identifies a stationary noise distractor presence in the open space 100 from the audio sensor data 10. In one example, any non-speech noise is designated as stationary noise. Stationary noise may include, for example, HVAC noise or printer noise. Sound map generation application 8 identifies a source location of the human speech distractor presence or the stationary noise distractor within the open space 100 by utilizing the audio sensor data 10.

In one example, sound map generation application 8 generates three dimensional sound map data 13 from audio sensor data 10 by detecting a voice activity from the audio sensor data 10, detecting a speech level of the voice activity from the audio sensor data 10, and identifying a source location of the voice activity within the open space. Sound map generation application 8 generates three dimensional sound map data 13 from audio sensor data 10 by detecting a stationary noise activity from the audio sensor data 10, detecting a stationary noise level of the stationary noise activity from the audio sensor data 10, and identifying a source location of the stationary noise activity within the open space.

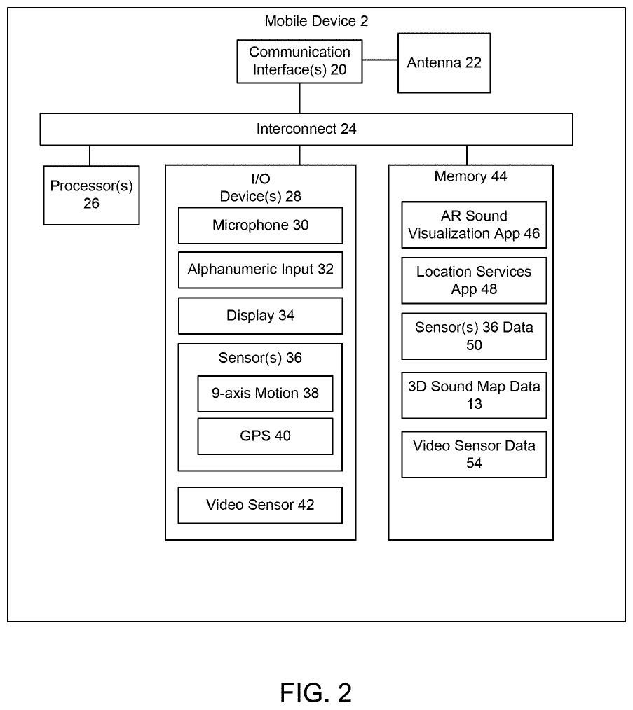

FIG. 2 illustrates a simplified block diagram of the mobile computing device 2 shown in FIG. 1 in one example. Mobile computing device 2 includes input/output (I/O) device(s) 28 configured to interface with the user, including a microphone 30 operable to receive a user voice input or other audio. I/O devices 28 include an alphanumeric input device 32, such as a keyboard, touchscreen, and/or a cursor control device. I/O device(s) 28 includes a video display 34, such as a liquid crystal display (LCD). I/O device(s) 28 may also include additional input devices and additional output devices, such as a speaker. I/O device(s) 28 include a video sensor 42 (e.g., a video camera). I/O device(s) 28 include sensor(s) 36 for determining location, orientation, and facing direction of the mobile computing device 2. For example, sensor(s) 36 include a 9-axis motion sensor 38 and global positioning system (GPS) receiver 40.

The mobile computing device 2 includes a processor 26 configured to execute code stored in a memory 44. Processor 26 executes an augmented reality visualization application 46 to generate and display an augmented reality visualization of the three dimensional sound map data 13. A location services application 48 identifies a current location of mobile computing device 2. In one example, the location of the mobile computing device 2 may be continuously monitored or monitored periodically as needed. In one example, mobile computing device 2 utilizes the Android operating system. Location services application 48 utilizes location services offered by the Android device (global positioning system (GPS), WiFi, and cellular network) to determine and log the location of the mobile device. For example, mobile computing device 2 includes the GPS receiver 40 for use by location services application 48. The GPS receiver 40 has an antenna to receive GPS information, including location information to indicate to the mobile computing device 2 where it is geographically located. In further examples, one or more of GPS, WiFi, or cellular network may be utilized to determine location. The cellular network may be used to determine the location of mobile computing device 2 utilizing cellular triangulation methods.

In one example, a Google Maps API is used which utilizes an Android phone's “location services” to compute the map location of the mobile computing device 2. These services consist of 2 options: GPS and Network (Cell Phone Location and Wi-Fi). The best source from whichever service is turned on and providing data is utilized. The combination of data supplied by one or more of the primary three location services (GPS, WiFi, and cell network) provide a high level of location accuracy.

While only a single processor 26 is shown, mobile computing device 2 may include multiple processors and/or co-processors, or one or more processors having multiple cores. The processor 26 and memory 44 may be provided on a single application-specific integrated circuit, or the processor 26 and the memory 44 may be provided in separate integrated circuits or other circuits configured to provide functionality for executing program instructions and storing program instructions and other data, respectively. Memory 44 also may be used to store temporary variables or other intermediate information during execution of instructions by processor 26. Mobile computing device 2 includes communication interface(s) 20, one or more of which may utilize an antenna 22. The communications interface(s) 20 may also include other processing means, such as a digital signal processor and local oscillators.

Communication interface(s) 20 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol. The specific design and implementation of the communications interfaces of the mobile computing device 2 is are dependent upon the communication networks in which the device is intended to operate.

In one example, communications interface(s) 20 include one or more short-range wireless communications subsystems which provide communication between mobile computing device 2 and different systems or devices. In one embodiment, communication interface(s) 20 may provide access to a local area network, for example, by conforming to IEEE 802.11b and/or IEEE 802.11g standards, and/or the wireless network interface may provide access to a personal area network, for example, by conforming to Bluetooth standards. For example, the short-range communications subsystem may include an infrared device and associated circuit components for short-range communication or a near field communications (NFC) subsystem.

Memory 44 may include both volatile and non-volatile memory such as random access memory (RAM) and read-only memory (ROM). Memory 44 may include a variety of applications executed by processor 26 capable of performing functions described herein.

Information/data utilized to assist in generating and displaying the augmented reality visualization of distractor data may be stored in memory 44. Such data includes, for example, sensor(s) 36 data 50 output from sensor(s) 36, three dimensional sound map data 13, and video sensor data 54 output from video sensor 42. Interconnect 24 may communicate information between the various components of mobile computing device 2.

Instructions may be provided to memory 44 from a storage device, such as a magnetic device, read-only memory, via a remote connection (e.g., over a network via communication interface(s) 20) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Mobile computing device 2 may include operating system code and specific applications code, which may be stored in non-volatile memory. An example of an operating system may include Android made by Google. For example the code may include drivers for the mobile computing device 2 and code for managing the drivers and a protocol stack for communicating with the communications interface(s) 20 which may include a receiver and a transmitter and is connected to an antenna 22. Communication interface(s) 20 provides a wireless interface for communication with server 6.

In one example operation of system 16, sound map generation application 8 at server 6 receives audio sensor data 10 from the plurality of microphones 4. Sound map generation application 8 generates three-dimensional sound map data 13 from the audio sensor data 10. Generation of the three-dimensional sound map data 13 includes (a) detecting a voice activity from the audio sensor data 10, (b) detecting a speech level of the voice activity from the audio sensor data 10, (c) identifying a source location of the voice activity within the open space 100, (d) detecting a stationary noise activity from the audio sensor data 10, (e) detecting a stationary noise level of the stationary noise activity from the audio sensor data 10, and (f) identifying a source location of the stationary noise activity within the open space 100.

Augmented reality sound visualization application 46 at mobile computing device 2 receives the three-dimensional sound map data 13, receives a video sensor 42 output (e.g., video sensor data 54), and receives sensor(s) 36 data 50 identifying the mobile computing device 2 location, orientation, and viewpoint. Augmented reality sound visualization application 46 generates an augmented reality visualization of the three-dimensional sound map data 13 utilizing the video sensor 42 output, the sensor(s) 36 data 50, and the three-dimensional sound map data 13. Augmented reality sound visualization application 46 outputs the augmented reality visualization on the video display 34.

In one embodiment, augmented reality sound visualization application 46 generates the augmented reality visualization by overlaying a visualization of the three-dimensional sound map data 13 on the video sensor output. For example, augmented reality sound visualization application 46 indicates a value of the speech level or a value of the stationary noise level by color at the source location of the voice activity or the source location of the stationary noise activity.

In one embodiment, augmented reality sound visualization application 46 captures with a video sensor 42 at a mobile computing device 2 a video image of the open space 100. Augmented reality sound visualization application 46 displays the video image on a video display 34 of the mobile computing device 2, and overlays a visualization of the three-dimensional sound map data 13 on the video image on the video display 34. Augmented reality sound visualization application 46 determines a camera field of view of the open space 100 at the mobile computing device 2 utilizing a mobile device location and a mobile device facing orientation within the open space 100. For example, augmented reality sound visualization application 46 indicates a value of the speech level or a value of the stationary noise level by color at the source location of the voice activity or the source location of the stationary noise activity. In one example, augmented reality sound visualization application 46 determines whether the speech level of the voice activity exceeds a speech threshold level and further determines whether the stationary noise level exceeds a stationary noise threshold level.

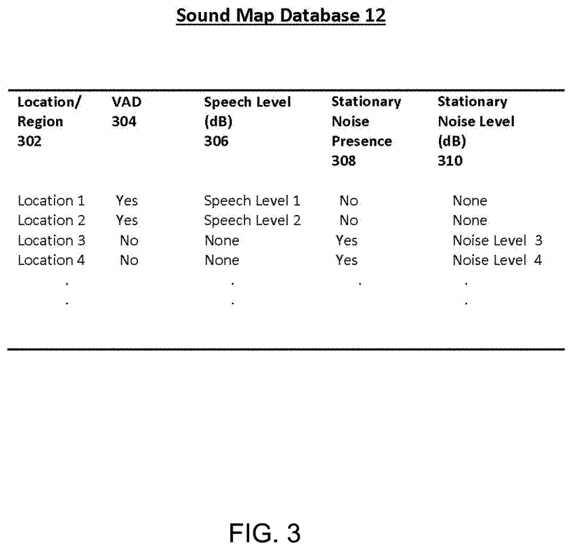

FIG. 3 illustrates a sound map database 12 of three dimensional sound map data 13 in one example. For example, sound map database 12 is generated from audio sensor data 10 and processed as described herein. Sound map database 12 includes location/region data 302, VAD data 304, speech level data 306, stationary noise presence data 308, and measured stationary noise level data 310. For each location/region, distraction activity is recorded. In the example illustrated in FIG. 3, Speech Level 1 is plotted as an augmented reality visualization on the video image of open space 100 at Location 1. In one embodiment, Location 1 is an x,y,z coordinate. In addition to measured noise levels, any gathered or measured parameter derived from microphone output data may be stored. Data in one or more data fields in the table may be obtained using a database and lookup mechanism.

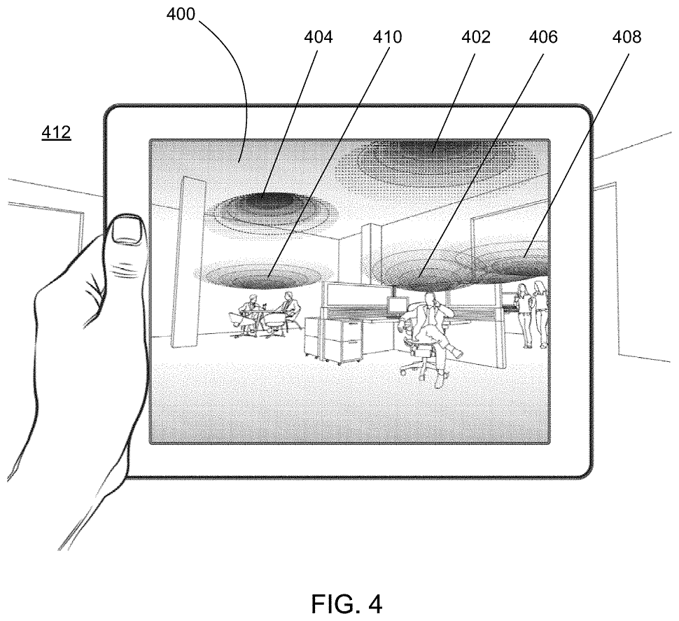

Augmented reality sound visualization application 46 visually indicates the speech level data 306 and stationary noise level data 310 on the video image of the open space captured by and displayed on mobile computing device 2 at the source location of the human speech distractor presence and source location of the stationary noise. FIG. 4 illustrates an augmented reality sound map visualization 400 of noise distraction activity in an open space 412 in an example where there are hot spot visualizations 402, 404 of stationary noise and hot spot visualizations 406, 408, and 410 of speech noise. Augmented reality sound map visualization 400 is a real-time visualization tool shown on mobile computing device 2 that presents distracting noise activity in open space 412.

In one example, augmented reality sound visualization application 46 visually indicates a value of the noise by color and radius extending from the source location. Augmented reality sound visualization application 46 may generate and display a time-lapse visualization of the sound. The more distracting an area is, the “hotter” or “redder” that space appears in the augmented reality sound map visualization 400 and the greater the radius of the visualization. In one embodiment, actual color is utilized to differentiate hot spots, such as the use of the color red to indicate a high or maximum level of distraction activity. In further examples, other graphical tools such as stippling may be utilized to differentiate varying levels of distraction activity. For example, as shown in FIG. 4, visualizations 402, 404, 406, 408, and 410 indicate hot spots of noise activity, wherein the level of distraction is greatest at the center of the region and decays with increasing distance from the distraction center. Visualizations 402, 404 of stationary noise are shown in a different color and/or using different stippling than visualizations 406, 408, and 410 of speech noise.

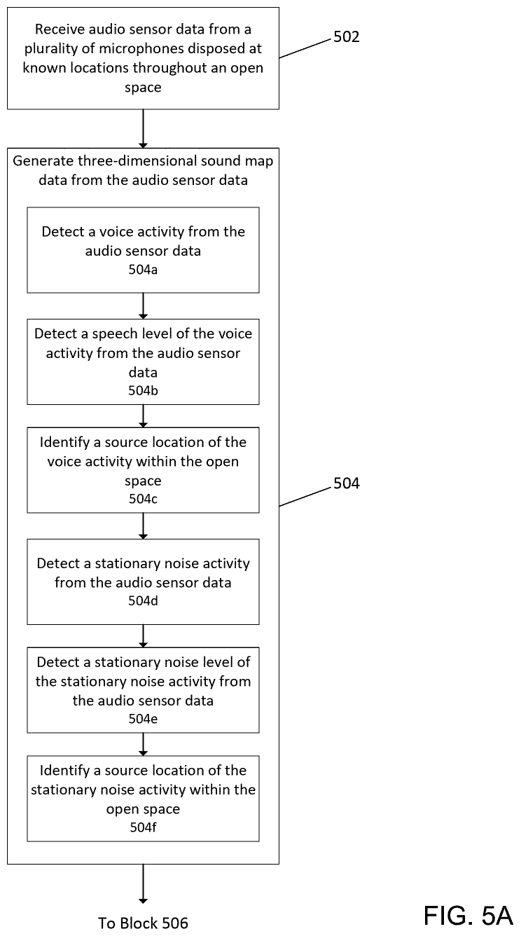

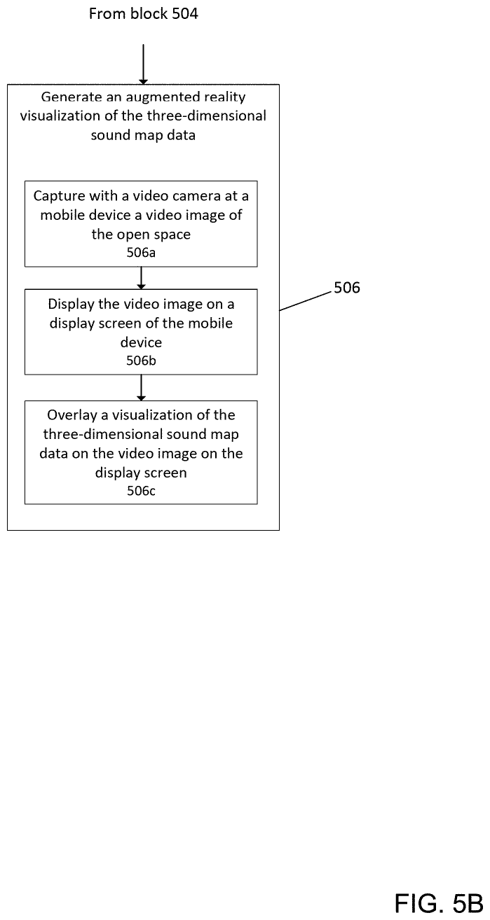

In various embodiments, the techniques of FIGS. 5A-5B discussed below may be implemented as sequences of instructions executed by one or more electronic systems. FIGS. 5A-5B are a flow diagram illustrating generating an augmented reality visualization of three-dimensional sound map data in one example. For example, the process illustrated may be implemented by the system shown in FIG. 1.

At block 502, an audio sensor data is received from a plurality of microphones disposed at known locations throughout an open space. In one example, the plurality of microphones is disposed within the open space in a manner wherein each microphone of the plurality of microphones corresponds to a region of the open space. In one example, each microphone is a part of a microphone array comprising six directional microphones oriented at sixty degree increments facing outward in the open space. In one example, one or more of the plurality of microphones is an omni-directional microphone.

At block 504, a three-dimensional sound map data is generated from the audio sensor data. Generating the three-dimensional sound map data includes blocks 504a-504f. At block 504a, a voice activity is detected from the audio sensor data. At block 504b, a speech level of the voice activity is detected from the audio sensor data. At block 504c, a source location of the voice activity within the open space is identified. At block 504d, a stationary noise activity is detected from the audio sensor data. At block 504e, a stationary noise level of the stationary noise activity is detected from the audio sensor data. At block 504f, a source location of the stationary noise activity within the open space is identified. In one example, the audio sensor data includes a plurality of measured decibel levels and the three-dimensional sound map data includes the plurality of measured decibel levels correlated to a plurality of locations. In one example, the process further includes determining whether the speech level of the voice activity exceeds a speech threshold level and further comprising determining whether the stationary noise level exceeds a stationary noise threshold level.

At block 506, an augmented reality visualization of the three-dimensional sound map data is generated. Generating the augmented reality visualization includes blocks 506a-506c. At block 506a, a video image of the open space is captured with a video camera at a mobile device. At block 506b, the video image is displayed on a display screen of the mobile device. At block 506c, a visualization of the three-dimensional sound map data is overlaid on the video image on the display screen. In one example, the audio sensor data is received at a central hub device from the plurality of microphones, and the method further includes receiving the audio sensor data at the mobile device from the central hub device.

In one example, overlaying the visualization of the three-dimensional sound map data on the video image on the display screen includes determining a camera field of view of the open space at the mobile device utilizing a mobile device location and a mobile device facing orientation within the open space. In one example, overlaying the visualization of the three-dimensional sound map data on the video image on the display screen includes indicating a value of the speech level or a value of the stationary noise level by color at the source location of the voice activity or the source location of the stationary noise activity.

FIG. 6 illustrates a system block diagram of a server 6 suitable for executing application programs that implement the methods and processes described herein in one example. The architecture and configuration of the server 6 shown and described herein are merely illustrative and other computer system architectures and configurations may also be utilized.

The exemplary server 6 includes a display 1003, a keyboard 1009, and a mouse 1011, one or more drives to read a computer readable storage medium, a system memory 1053, and a fixed storage 1055 which can be utilized to store and/or retrieve software programs incorporating computer codes that implement the methods and processes described herein and/or data for use with the software programs, for example. For example, the computer readable storage medium may be a CD readable by a corresponding CD-ROM or CD-RW drive 1013 or a flash memory readable by a corresponding flash memory drive. Computer readable medium typically refers to any data storage device that can store data readable by a computer system. Examples of computer readable storage media include magnetic media such as hard disks, floppy disks, and magnetic tape, optical media such as CD-ROM disks, magneto-optical media such as optical disks, and specially configured hardware devices such as application-specific integrated circuits (ASICs), programmable logic devices (PLDs), and ROM and RAM devices.

The server 6 includes various subsystems such as a microprocessor 1051 (also referred to as a CPU or central processing unit), system memory 1053, fixed storage 1055 (such as a hard drive), removable storage 1057 (such as a flash memory drive), display adapter 1059, sound card 1061, transducers 1063 (such as loudspeakers and microphones), network interface 1065, and/or printer/fax/scanner interface 1067. The server 6 also includes a system bus 1069. However, the specific buses shown are merely illustrative of any interconnection scheme serving to link the various subsystems. For example, a local bus can be utilized to connect the central processor to the system memory and display adapter. Methods and processes described herein may be executed solely upon CPU 1051 and/or may be performed across a network such as the Internet, intranet networks, or LANs (local area networks) in conjunction with a remote CPU that shares a portion of the processing.

While the exemplary embodiments of the present invention are described and illustrated herein, it will be appreciated that they are merely illustrative and that modifications can be made to these embodiments without departing from the spirit and scope of the invention. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A method comprising:
receiving an audio sensor data from a plurality of microphones disposed at known locations throughout an open space;
generating a three-dimensional sound map data from the audio sensor data comprising:
detecting a voice activity from the audio sensor data;
detecting a speech level of the voice activity from the audio sensor data;
identifying a source location of the voice activity within the open space;
detecting a stationary noise activity from the audio sensor data;
detecting a stationary noise level of the stationary noise activity from the audio sensor data;
identifying a source location of the stationary noise activity within the open space; and
generating an augmented reality visualization of the three-dimensional sound map data comprising:
capturing with a video camera at a mobile device a video image of the open space;
displaying the video image on a display screen of the mobile device; and
overlaying a visualization of the three-dimensional sound map data on the video image on the display screen.

2. The method of claim 1, wherein the plurality of microphones are disposed within the open space in a manner wherein each microphone of the plurality of microphones corresponds to a region of the open space.

3. The method of claim 2, wherein each microphone is a part of a microphone array comprising six directional microphones oriented at sixty degree increments facing outward in the open space.

4. The method of claim 1, wherein one or more of the plurality of microphones is an omni-directional microphone.

5. The method of claim 1, wherein the audio sensor data comprises a plurality of measured decibel levels and the three-dimensional sound map data comprises the plurality of measured decibel levels correlated to a plurality of locations.

6. The method of claim 1, wherein overlaying the visualization of the three-dimensional sound map data on the video image on the display screen comprises indicating a value of the speech level or a value of the stationary noise level by color at the source location of the voice activity or the source location of the stationary noise activity.

7. The method of claim 1, wherein overlaying the visualization of the three-dimensional sound map data on the video image on the display screen comprises determining a camera field of view of the open space at the mobile device utilizing a mobile device location and a mobile device facing orientation within the open space.

8. The method of claim 1, further comprising determining whether the speech level of the voice activity exceeds a speech threshold level and further comprising determining whether the stationary noise level exceeds a stationary noise threshold level.

9. The method of claim 1, wherein the audio sensor data is received at a central hub device from the plurality of microphones, and the method further comprises receiving the audio sensor data at the mobile device from the central hub device.

10. A system comprising:
a plurality of microphones disposed at known locations throughout an open space to output an audio sensor data;
a first computing device comprising:
a first device communications interface;
one or more first device processors;
one or more first device memories storing one or more first device application programs executable by the one or more first device processors, the one or more first device application programs comprising instructions to:
receive the audio sensor data from the plurality of microphones;
generate a three-dimensional sound map data from the audio sensor data comprising instructions to:
detect a voice activity from the audio sensor data;
detect a speech level of the voice activity from the audio sensor data;
identify a source location of the voice activity within the open space;
detect a stationary noise activity from the audio sensor data;
detect a stationary noise level of the stationary noise activity from the audio sensor data;
identify a source location of the stationary noise activity within the open space; and
a second computing device comprising:
a second device communications interface for receiving the three-dimensional sound map data from the first computing device;
one or more processors;
a video sensor providing a video sensor output;
a video display device;
one or more location sensors providing a sensor output identifying a device location and viewpoint;
one or more second device computer memories storing one or more second device application programs executable by the one or more second device processors, the one or more second device application programs comprising instructions to:
receive the three-dimensional sound map data;
receive the video sensor output;
receive the sensor output identifying the device location and viewpoint;
generate an augmented reality visualization of the three-dimensional sound map data utilizing the video sensor output, the sensor output identifying the device location and viewpoint, and the three-dimensional sound map data; and
output the augmented reality visualization on the video display device.

11. The system of claim 10, wherein the first computing device comprises a central hub device, and wherein the second computing device comprises a mobile device located within the open space.

12. The system of claim 10, wherein the plurality of microphones are disposed within the open space in a manner wherein each microphone of the plurality of microphones corresponds to a region of the open space.

13. The system of claim 10, wherein the audio sensor data comprises a plurality of measured decibel levels and the three-dimensional sound map data comprises the plurality of measured decibel levels correlated to a plurality of locations.

14. The system of claim 10, wherein the instructions at the second computing device to generate the augmented reality visualization comprise instructions to overlay a visualization of the three-dimensional sound map data on the video sensor output by indicating a value of the speech level or a value of the stationary noise level by color at the source location of the voice activity or the source location of the stationary noise activity.

15. A system comprising:
a plurality of microphones disposed at known locations throughout an open space to output an audio sensor data;
one or more video sensors disposed in the open space to output a video sensor data; and
one or more computing devices comprising:
one or more processors;
one or more display devices to display the video sensor data;
one or more memories storing one or more application programs executable by the one or more processors, the one or more application programs comprising instructions to:
receive the audio sensor data from the plurality of microphones;
generate a three-dimensional sound map data from the audio sensor data comprising instructions to:
detect a voice activity from the audio sensor data;
detect a speech level of the voice activity from the audio sensor data;
identify a source location of the voice activity within the open space;
detect a stationary noise activity from the audio sensor data;
detect a stationary noise level of the stationary noise activity from the audio sensor data;
identify a source location of the stationary noise activity within the open space; and
generate an augmented reality visualization of the three-dimensional sound map data comprising instructions to:
capture with the one or more video sensors a video image of the open space;
display the video image on the one or more display devices; and
overlay a visualization of the three-dimensional sound map data on the video image on the one or more display devices.

16. The system of claim 15, wherein the plurality of microphones are disposed within the open space in a manner wherein each microphone of the plurality of microphones corresponds to a region of the open space.

17. The system of claim 15, wherein the audio sensor data comprises a plurality of measured decibel levels and the three-dimensional sound map data comprises the plurality of measured decibel levels correlated to a plurality of locations.

18. The system of claim 15, wherein the instructions to overlay the visualization of the three-dimensional sound map data on the video image on the one or more display devices comprises instructions to indicate a value of the speech level or a value of the stationary noise level by color at the source location of the voice activity or the source location of the stationary noise activity.

19. The system of claim 15, wherein the instructions to overlay the visualization of the three-dimensional sound map data on the video image on the one or more display devices comprises instructions to determine a sensor field of view of the open space at the one or more video sensors utilizing a video sensor location and a video sensor facing orientation within the open space.

20. The system of claim 15, wherein the one or more computing devices comprises a central hub device and wherein the audio sensor data is received at the central hub device from the plurality of microphones, and wherein the one or more computing devices further comprise a mobile device and the audio sensor data is received at the mobile device from the central hub device.
